(19) United States
(12) Patent Application Publication
(10) Pub. No.: US 2025/0363786 A1
(43) Pub. Date: Nov. 27, 2025

(54) Method and Device for Cleaning Up of an Image Data Set

(71) Applicant: Robert Bosch GmbH, Stuttgart (DE)

(72) Inventors: Patrik Roland Czako, Jászfényszaru (HU); Istvan Remenyi, Tata (HU); Márk Petö, Budapest (HU)

(21) Appl. No.: 19/213,781

(22) Filed: May 20, 2025

(30) Foreign Application Priority Data
May 24, 2024 (EP) 24178041.0

(51) Int. Cl. G06V 10/774; G06V 10/75; G06V 10/776; G06V 20/40

(52) U.S. Cl. CPC G06V 10/7747; G06V 10/751; G06V 10/776; G06V 20/46

(57) ABSTRACT

A method for cleaning up an image data set used for training, validating, and/or testing a machine learning model includes providing the image data set that includes a plurality of images. The method also includes comparing a predetermined comparison image of the plurality of images with at least a portion of remaining images of the plurality of images by applying an intersection-over-union filter. Based on the comparison, the method includes determining at least one redundant image with respect to the predetermined comparison image in at least the portion of remaining images of the plurality of images, and cleaning up the image data set by removing the at least one redundant image from the plurality of images.

This application claims priority under 35 U.S.C. § 119 to patent application no. EP 24178041.0, filed on May 24, 2024 in Europe, the disclosure of which is incorporated herein by reference in its entirety.

The disclosure relates to a method and a device for cleaning up an image data set used for training and/or validating and/or testing a machine learning model. The disclosure further relates to a method for training and/or validating and/or testing a machine learning model usable for classifying and/or segmenting image data, in particular in automatic unpacking machines and/or in vehicles having at least one autonomous driving function and/or in automated optical inspection.

### BACKGROUND

In automation technology, the development of automatic unpacking machines presents a challenge, especially due to the need to process large amounts of data. This data typically comes from camera data streams that deliver a plurality of images in rapid succession. One problem is coping with the inherent redundancy of these image sequences. Therefore, to develop efficient and precise prototypes for content detection systems, semantic redundancy filtering is desired. This technique helps to identify and eliminate unnecessary repetitions in the data resulting not only from the sequentiality, but also from the overlapping content features of the images.

Semantic redundancy filtering, which was used in the past primarily in the field of image classification, today utilizes methods such as agglomerative clustering in latent space. This approach allows the importance and information content of individual data samples to be analyzed and weighted accordingly in the context of the entire data set. Such techniques are critical to reducing data volumes without losing relevant information.

Furthermore, the treatment of inter-pixel redundancy is known, such as buffer allocation methods, which serve to minimize pixel-level overlaps. Furthermore, some content retention techniques such as Perceptual Hashing and Deep Perceptual Hashing are already known that aim to protect the essential features of the images while maintaining the independence from visual changes such as rotation, scale, or compression.

Furthermore, so-called non-max suppression is known in object detection, often coupled with analysis of validation metrics that account for various overlap threshold values for a fixed classification confidence. These techniques are particularly useful for neural networks used in single image object detection and assist in precisely classifying objects during training at selected regions of interest.

While some approaches are already known, there is still room for development.

It is therefore an object of the disclosure to provide an improved method and/or device in this respect.

The task is solved by a method according to the features disclosed herein. The task is further solved by a device as disclosed herein.

### SUMMARY

According to a first aspect, a method for cleaning up an image data set used for training and/or validating and/or testing a machine learning model is proposed, the method comprising the steps of (i) providing the image data set comprising a plurality of images; (ii) comparing a, in particular predetermined, comparison image of the one plurality of images, each with at least a portion of the remaining images of the plurality of images by applying an intersection-over-union filter; (iii) based on the comparison, determining at least one image redundant with respect to the comparison image in at least the portion of the remaining images of the plurality of images; and (iv) cleaning up the image data set by removing the at least one redundant image from the plurality of images.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to a second aspect, a device for cleaning up an image data set is proposed, which is used for training and/or validating and/or testing a machine learning model, wherein the device comprises an evaluation and computing device that is designed to perform the following steps (i) providing the image data set comprising a plurality of images; (ii) comparing a, in particular predetermined, comparison image of the one plurality of images, each with at least a portion of the remaining images of the plurality of images by applying an intersection-over-union filter; (iii) based on the comparison, determining at least one image redundant with respect to the comparison image in at least the portion of the remaining images of the plurality of images; and (iv) cleaning up the image data set by removing the at least one redundant image from the plurality of images.

The explanations given for the method apply to the device accordingly. In this regard, any linguistic modifications of features formulated in terms of the method can be reformulated for the device in accordance with standard linguistic practice, without such formulations having to be explicitly listed here.

While active learning is used for unlabeled data, an additional importance classification may be used with less computational effort to clean up the semantically redundant data. Assuming that a data stream does not originate from an open-world use case (image data is part of a closed system) and images of scenes with a fixed or unchanging image background are captured, a possibly changing image foreground may be examined and analyzed for redundancies in this way. Utilizing a simplified predictive space, such as object patch annotations, in which only the image foreground changes, makes the intersection-over-union (IoU) comparison available during the pre-processing of the image data.

With the present method and device, any semantically redundancy-free data sets may be created for training and/or validating and/or testing machine learning models. The intersection-over-union (IoU) dimension is used to clean up the initial amount of image data.

In the present case, for example, two images with a highest IoU dimension within the same class can be compared with each other. In this way, preferably two images may be considered similar and thus redundant if at least one object in the image pair compared does not satisfy the filter criteria of the IoU.

In so doing, relevant key images or comparison images can be selected on the basis of which the comparison is to be made. In this way, semantically similar and thus redundant, relevant key images can be selected in order to, in particular automatically, exclude them from the data set or data set splits. This makes the metric more robust.

The main innovation of the IoU-based semantic image redundancy filter over data driven active solutions can be considered for data sets that have a static or quasi-static image background, so that the filtering process can focus on dynamics of the objects located in the image foreground between the images to be compared. If this assumption is made, the IoU-based semantic redundancy filter, for example, proves to be more efficient and effective than the introduction of new labels for semantic redundancy in detection.

Intersection-over-union (IoU) is a metric used in computer vision, particularly in tasks such as object detection and/or segmentation. IoU measures the intersection between two regions-in particular between a predicted range (by a model) and a true range (actual position of the object)-to assess the accuracy of the prediction. An IoU value of 1 means a perfect match, while a value of 0 means that the prediction and true range do not overlap. For example, a threshold value for IoU (for example 0.5) may be set to decide whether a prediction is to be considered accurate. In the present case, it can preferably be decided on the basis of this threshold value whether an image is considered similar to the comparison image, and thus redundant, or dissimilar to the comparison image, and thus non-redundant.

In a further aspect, it is proposed that applying the intersection-over-unit filter comprises comparing at least one keyframe comprising at least one object in the at least one comparison image with a keyframe, which is preferably set at the same position as in the comparison image, of the respective image of the remaining images to be compared.

In the computer vision, a keyframe is preferably defined as a representative frame within a sequence of images or videos that has important or significant information for the processing tasks. In object tracking and similar tasks, a keyframe can be used to set important positions of an object in the video. The relationship between keyframes and intersection-over-union (IoU) in computer vision, especially in video analytics or object tracking, results from assessing the accuracy of object detection and tracking across multiple frames. Keyframes help identify significant points in the video sequence on which the IoU metric can be applied in order to assess the accuracy of object tracking. The IoU is calculated to measure how well the tracked object in these keyframes matches the manually marked ground truth data.

In a further aspect it is proposed that providing the image data set comprises a prior selection of key images serving as the at least one comparison image, wherein the key images could be redundant.

Selecting visually relevant key images helps clean up the image data set and maintain possible redundant images. Relevant key frames that could be redundant are preferably selected from the provided, preferably labelled image data set, which can be used for object detection and in which images are labelled by setting bounding boxes or keyframes that identify objects in the scene. In the simplest case, this could mean that some of the undesirable redundant images are selected manually, but other redundancy measures could also be used to select relevant key images. In this case, an already cleaned-up image data set can preferably be viewed. In addition, it is possible to create subsets in any ratio from the cleaned-up image data set, e.g. three-fold data split into 60% training data, 20% validation data and 20% test data.

The preferably selected relevant key images are compared as the comparison images with the remaining images of the preferably pre-cleaned image data set or any subset of the image data set. The images of the image data set preferably each comprise a static background image with foreground objects dynamically changing between the sequential images.

In a further aspect, it is proposed that determining the at least one image redundant with respect to the comparison image in at least the portion of the remaining images of the plurality of images comprises matching the respective images with a predetermined threshold value or similarity measure.

In the present case, the IoU filter is preferably applied per common class to relevant key images and all remaining images. The IoU filter is preferably fixed, in particular with a threshold value between 0.0 and 1.0, for example 0.9. Key images that are preferably relevant are used. It is then iterated over all classes, wherein a similarity measure to a different image is calculated for each class and preferably for each relevant key image. The objects included in each key image are preferably compared with the respective objects of the images to be compared. This may also be performed for only a subset of images. If at least one overlapping object is found, the respectively compared images are considered to be semantically redundant.

In a further aspect, it is proposed that the at least one comparison image is selected from a subset of the image data set, and the comparison image is compared to images of another subset of the image data set.

Particularly preferably, the pre-filtered images are compared with the cleaned-up image data set. This step preferably relates to the assignment of the redundant images to a subset different from the examined subsets of the image data set.

Comparing the, in particular predetermined, comparison image of the one plurality of images, each with at least a portion of the remaining images of the plurality of images, by applying an intersection-over-union filter; and determining at least one image redundant with respect to the comparison image in at least the portion of the remaining images of the plurality of images based on the comparison may preferably be performed for multiple subsets of the image data set separately or comparatively. Thus, the comparison and determination may preferably be performed for pairs of subsets of the image data, e.g. in the case of a three-way split for the pairs of training validation data, training test data, and validation test data. For example, if the subsets of the training image data and the validation image data are compared with each other and relevant key images are selected from the training subset, the similar and thus redundant images may be removed from the validation subset in order to clean up semantic similarities from the validation subset.

The cut-off threshold can also be used to split the image data set, for example to form new subsets from the image data set. The newly formed subsets may deviate from an original ratio, e.g. 60%-20%-20% cut-offs. Therefore, this step is preferred for randomly re-filtering the non-redundant dataset samples with the original cut-off ratios before using them for training and/or testing and/or validating a machine learning model. If the image sequence is not exact, i.e., if the images are not consecutive, the present method still functions as a redundancy filter.

In a further aspect, it is proposed that the plurality of image data be captured sequentially by an imaging sensor. “Sequentially” refers to image data captured in a particular order or sequence. The “sequential processing” describes the processing of image data in the order in which its arrives or is created. The at least one imaging sensor may comprise a camera, an ultrasonic sensor, a lidar sensor, a radar sensor, or the like.

In a further aspect, it is proposed that a method for training and/or validating and/or testing a machine learning model, which is usable for classifying and/or segmenting image data in particular, but not limiting, on automatic unloading machines and/or on vehicles having at least one autonomous driving function and/or in automatic optical inspection, the method comprising training and/or validating and/or testing the machine learning model based on an image data set cleaned up according to the method claimed herein.

It is understood that the method for training and/or validating and/or testing a machine learning model used for classifying and/or segmenting image data may also be used in other technical areas. As an example, here, medical technology, security technology, monitoring technology, authentication technology, automation technology, robotics, or the like.

The method for cleaning up the data set can in principle be used where image data is captured in a large amount, possibly sequentially in a fast sequence. The method is particularly advantageous if an image background remains unchanged in the image data, and changes occur in an image foreground or upstream image plane.

In a further aspect, a control unit is also claimed which is comprised in a vehicle having an autonomous driving function and/or a robotic system and/or an industrial machine, and on which a machine learning model trained and/or validated and/or tested according to the present method is executable in one of its aspects.

In a further aspect, a computer program comprising program code is claimed for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and refinements may be combined with one another as desired.

Further possible designs, refinements and implementations of the disclosure also include combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

The figures show:

FIG. 1 shows a schematic flowchart of an exemplary embodiment of the method;

FIG. 2 shows a schematic block diagram of an exemplary embodiment of the method;

FIG. 3 shows a schematic visualization of redundant images; and

FIG. 4 shows a schematic visualization of non-redundant images.

In the figures of the drawings, identical reference numbers denote identical or functionally identical elements, parts or components, unless stated otherwise.

### DETAILED DESCRIPTION

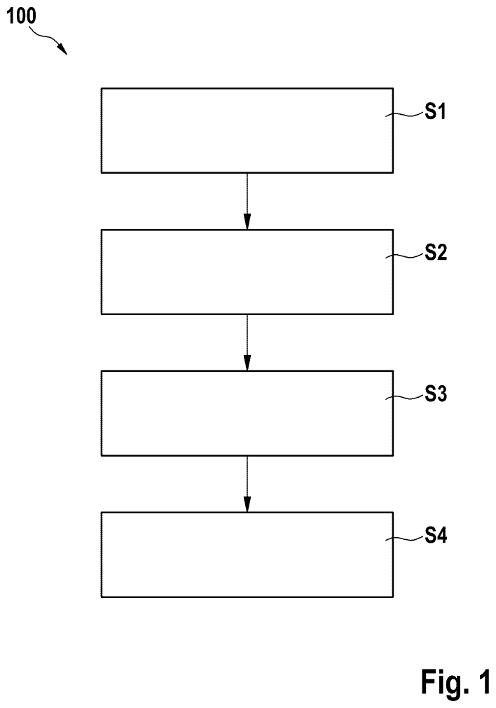

FIG. 1 shows a schematic flowchart of a method for cleaning up an image data set used to train and/or validate and/or test a machine learning model.

The method can be carried out in any embodiment, at least in part, by a device 100 which may comprise several components not shown in detail, for example one or more provision devices and/or at least one evaluation and computing device. It is understood that the provision device may be configured together with the evaluation and computing device or may be different from it. Furthermore, the device 100, which may be part of a system, may comprise a storage device and/or an output device and/or a display device and/or an input device.

The computer-implemented method comprises at least the following steps:

In a step S1, the image data set is provided, comprising a plurality of images.

In a step S2, a comparison of a, in particular predetermined, comparison image of the one plurality of images, each with at least a portion of the remaining images of the plurality of images is performed by applying an intersection-over-union filter.

In a step S3, based on the comparison, a determination is made of at least one image redundant with respect to the comparison image in at least the portion of the remaining images of the plurality of images.

In a step S4, a clean-up of the image data set is performed by removing the at least one redundant image from the plurality of images.

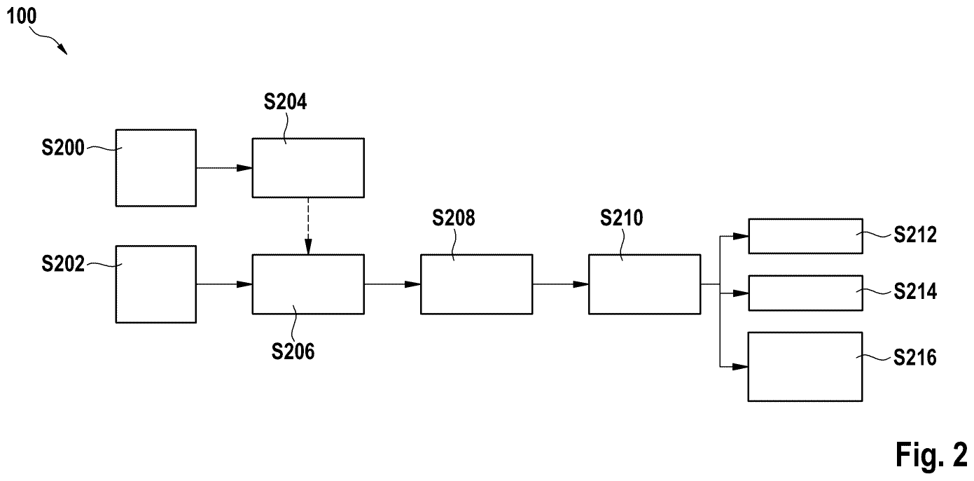

FIG. 2 shows a schematic block diagram of an exemplary embodiment of the present method. In a step S200, a subset of an image data set to be used for training is provided. In a step S202, a subset of an image data set to be used for validation is provided. Preferably, in a step S204, a visual selection of non-relevant keyframes is performed in order to provide a pre-cleaned subset in this way. In a step S206, an IoU filter is applied to the two subsets for each common class for at least one comparison image with all remaining images of the respective subset to be compared.

In an optional step S208, the filtered images are compared with the images cleaned-up subset of the image data set. In an optional step S210, a cut-off threshold value is applied in order to form a new subset division. In this way, in a step S212 and S214, a new training data subset and a new validation data subset may be provided. Furthermore, a subset of image data that was detected as redundant images may be provided in an optional step S216.

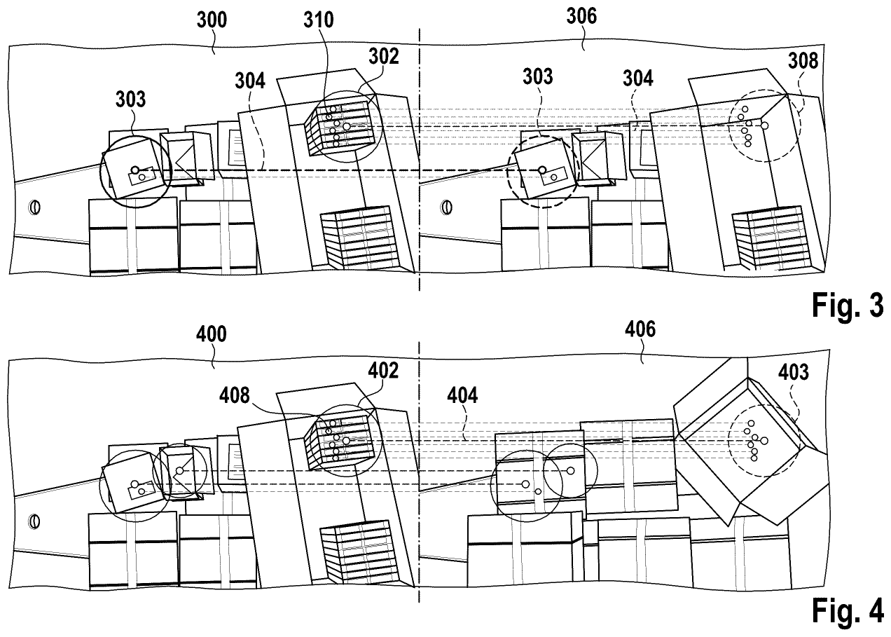

FIGS. 3 and 4 show schematic illustrations of images of an image data set that is to be cleaned up or filtered or freed from redundant images according to the method. The images of the image data set are preferably collected sequentially. For example, the images are from a camera that provides sequential images of a scene according to a predetermined frame rate. For example, one possible redundancy factor is that the successive images do not change in depth from image to image due to the nature of the scene, which is sampled at a frame rate of 30 frames per second, for example.

In the example shown, images of a scene, in the present case a warehouse, were captured. The scene includes packaging material, e.g., boxes, cartons, packages, etc., in various states, for example, open, semi-open, closed, etc., recorded from above in a static environment. In the present case, the background of the scene does not change. In order to ensure that the data set is as complete as possible, the packaging material was recorded in the present case in different positions, orientations and/or sizes.

Thus, a generalization capability of detecting the objects may be evaluated. Furthermore, such sample redundancy may be avoided. As already described, similar images are now to be sorted out from this data set in order to clean up the data set of undesired redundancies. In the present case, the focus is not on a similarity at one level of the image features, as packaging material, for example, appears to be very similar when viewed from above in the scale captured.

On the other hand, the content of the packaging material is taken into account, wherein preferably only the volumetric information is taken into account. As described above, the IoU metric is used to compare the images in order to find packaging material position arrangements that are recognized as similar to each other in a pair of images being compared.

FIG. 3 shows a schematic visualization of redundant image data. In the left-hand image 300, a relevant keyframe 302, 303 is shown in circular form. The keyframe 302, 303 represents a current object that is compared to a respective dashed line 304 in the right image 306. This is a non-redundant change because in the example, in the right-hand image 306, there is no object in the area of the schematically indicated further keyframe 308. On the other hand, the keyframe 303 intersects between the two images 300, 306, which is indicated by the fact that the reference number 303 is drawn in the left image 300 and in the right image 306. Thus, a redundant object was found so that the entire right image 306 is referred to as redundant.

The smaller circles 310 displayed in the images 300, 306 represent smaller objects that may also be used for the redundancy comparison. The right-hand image 306 recognized as redundant is filtered out of the image data set on the basis of the dashed keyframe 303 or object using the IoU-based algorithm described above or by the present method.

FIG. 4 shows a schematic visualization of non-redundant images. In the left image 400, a relevant keyframe 402, 403 is displayed as a circle and represents the comparison of all objects by means of the respective dashed line 404 representing the right image 406. Smaller frames 408 or smaller circles represent smaller objects that may also be used for the redundancy comparison. In the example, the right image 406 is detected as a non-redundant image because no single object intersects between the left image 400 and the right image 406.

What is claimed is:

1. A method for cleaning up an image data set used for training, validating, and/or testing a machine learning model, the method comprising:
providing the image data set comprising a plurality of images;
comparing a predetermined comparison image of the plurality of images with at least a portion of remaining images of the plurality of images, by applying an intersection-over-union filter, for which a threshold value is set, wherein applying the intersection-over-union filter comprises comparing at least one keyframe, which comprises at least one object in the predetermined comparison image, with a keyframe, which is set at a same position as in the predetermined comparison image, of a respective image of the portion of remaining images to be compared;
based on the threshold value, determining at least one redundant image with respect to the predetermined comparison image in at least the portion of remaining images of the plurality of images; and
cleaning up the image data set by removing the at least one redundant image from the plurality of images.

2. The method according to claim 1, wherein:
providing the image data set comprises selecting key images serving as the predetermined comparison image, and
the key images are redundant.

3. The method according to claim 1, wherein determining the at least one redundant image with respect to the predetermined comparison image in at least the portion of remaining images of the plurality of images comprises matching respective images with a predetermined threshold value.

4. The method according to claim 1, wherein:
the predetermined comparison image is selected from a subset of the image data set, and
the predetermined comparison image is compared to images of another subset of the image data set.

5. The method according to claim 1, wherein images of the plurality of images are captured sequentially by an imaging sensor.

6. A method for training, validating, and/or testing a machine learning model, the machine learning model usable for classifying and/or segmenting image data on automatic unloading machines, on vehicles having at least one autonomous driving function, and/or in automatic optical inspection, the method comprising:
cleaning up an image data set according to the method of claim 1; and
training, validating, and/or testing the machine learning model based on the cleaned-up image data set.

7. The method according to claim 1, wherein a computer program includes program code to execute at least portions of the method when the computer program is executed on a computer.

8. A non-transitory computer-readable data carrier having program code of a computer program to execute at least portions of the method according to claim 1 when the computer program is executed on a computer.

9. A device for cleaning up an image data set used for training, validating, and/or testing a machine learning model, the device comprising:
an evaluation and computing device configured to:
provide the image data set comprising a plurality of images;
compare a predetermined comparison image of the plurality of images with at least a portion of remaining images of the plurality of images, by applying an intersection-over-union filter, for which a threshold value is set, wherein applying the intersection-over-union filter comprises comparing at least one keyframe, which comprises at least one object in the predetermined comparison image, with a keyframe, which is set at a same position as in the predetermined comparison image, of a respective image of the portion of remaining images to be compared;
based on the threshold value, determine at least one redundant image with respect to the predetermined comparison image in at least the portion of remaining images of the plurality of images; and
clean up the image data set by removing the at least one redundant image from the plurality of images.
